(19) United States
(12) Patent Application Publication
(10) Pub. No.: US 2023/0381833 A1
(43) Pub. Date: Nov. 30, 2023

(54) Non-Woven Fabric Separation Mechanism for Dry-Process Paper Machine

(71) Applicant: Nantong University, Nantong (CN)

(72) Inventor: Wenyan GU, Nantong (CN)

(21) Appl. No.: 18/200,599

(22) Filed: May 23, 2023

(30) Foreign Application Priority Data
May 31, 2022 (CN) 202210605430.0

(51) Int. Cl. B08B 7/00; B08B 13/00

(52) U.S. Cl. CPC B08B 7/0028; B08B 13/00

(57) ABSTRACT

The present disclosure relates to the technical field of non-woven fabric production. Disclosed is a non-woven fabric separation mechanism for a dry-process paper machine. The separation mechanism includes a body; a conveyor assembly penetrates inside the body, and the conveyor assembly is connected to the body by means of a support frame; a separation cylinder is mounted above the conveyor assembly; a third rotary shaft penetrates inside the separation cylinder; and an end of the third rotary shaft is connected to the body by means of a first connecting frame.

### CROSS-REFERENCE TO RELATED APPLICATION

The present disclosure claims priority to Chinese Patent Application No. 202210605430.0 filed to the China National Intellectual Property Administration on May 31, 2022 and entitled “Non-Woven Fabric Separation Mechanism for Dry-Process Paper Machine”, the disclosure of which is hereby incorporated by reference in its entirety.

### TECHNICAL FIELD

The present disclosure relates to the technical field of non-woven fabric processing and surface dust removal, and specifically to a non-woven fabric separation mechanism for a dry-process paper machine.

### BACKGROUND

With the development of science and technology and the continuous progress of the society, a dry-process paper machine, also known as a non-woven fabric paper machine, is a technical apparatus that integrates textile and papermaking. During manufacturing and processing of non-woven fabrics, the non-woven fabrics may be processed by means of two manners. The first manner is a combed-type formation method, which is to perform continuous shaping or random arrangement on dispersed fibers, so as to form a web structure; and then perform reinforcement by using mechanical, thermal adhesion or chemical methods. The second manner is an airflow-type formation method, which is to suck and settle the dispersed fibers on a workbench by means of a vacuum technology, and then form the non-woven fabrics by means of dipping, extrusion and drying. In addition, when the non-woven fabrics are manufactured, the excess fibers attached to the surfaces of the non-woven fabrics need to be separated by means of a separation mechanism.

The current non-woven fabric separation mechanism is large in occupied space during using, and the exposed area of an adhesive band for adhesion and separation of the fibers attached on the surfaces of the non-woven fabrics is excessively large, causing airborne dust to be attached on the surfaces, resulting in low using efficiency of the separation mechanism, thereby affecting a separation effect on the non-woven fabrics.

The related patent document with a publication number CN112354904A discloses a dust-proof material-rolling apparatus for non-woven fabric processing. The apparatus includes a box body; a working cavity is provided in the box body; an inner bottom portion of the working cavity is provided with a water storage tank; the right sidewall of the box body is fixedly connected to two mounting plates; a sliding plate for moving up and down is horizontally provided in the working cavity, and the sliding plate is slidably connected to the inner wall of the working cavity; and the sliding plate is elastically connected to the inner top of the working cavity by means of two first springs. In the technical solution, dust on non-woven fabrics is removed by moving an against rod against the non-woven fabric, and the dust on the upper surface of the non-woven fabric is also removed by blowing air, such that a dust removal effect is improved. However, the technical solution has the defect of inadequate removal by shaking to make the dust fall off.

### SUMMARY

A non-woven fabric separation mechanism for a dry-process paper machine includes a body. A conveyor assembly penetrates inside the body, and the conveyor assembly is connected to the body by means of a support frame; a separation cylinder is mounted above the conveyor assembly; a third rotary shaft penetrates inside the separation cylinder; an end of the third rotary shaft is connected to the body by means of a first connecting frame, and the other side of the outer wall of the third rotary shaft is connected to a second connecting frame; a motor is mounted at an end portion of the third rotary shaft; a first rolling cylinder is mounted on one inner side of the separation cylinder; the first rolling cylinder is connected to the separation cylinder by means of a first rotary shaft; a second rolling cylinder is mounted on the other inner side of the separation cylinder; and the second rolling cylinder is connected to the separation cylinder by means of a second rotary shaft; the middle portion of the adhesive band is placed on the outer wall of the separation cylinder; one end of the adhesive band is in winding connection with the first rolling cylinder, and the other end of the adhesive band is in winding connection with the second rolling cylinder; one side of the outer wall of the separation cylinder is connected to a fixed rod, and a movable cover is mounted on the other side of the outer wall of the separation cylinder; one side of the first connecting frame that is close to the separation cylinder is provided with a preformed groove, and slope portions are distributed on the inner side of the preformed groove; one sides of the slope portions are connected to a horizontal portion; and a telescoping assembly is connected to a lower part of the side of the second connecting frame that is close to the separation cylinder.

In some embodiments, a supporting rod is connected on a bottom end of the body; the outer wall of the separation cylinder is provided with a preformed channel; the conveyor assembly includes a conveyor belt, and a conveyor wheel is wound on the inner wall of the conveyor belt; the conveyor wheel is connected to the support frame by means of an output shaft; a fixed magnet is inlaid in the surface of the conveyor belt, and the surface of the conveyor belt is connected to a clamping block; and a non-woven fabric body is placed on the surface of the conveyor belt, and a movable magnet is mounted on one side of the non-woven fabric body.

In some embodiments, one side of the outer wall of the first rotary shaft is connected to a first gear; a second gear is mounted on one side of the outer wall of the second rotary shaft; and a third gear is fixed on one side of the outer wall of the third rotary shaft.

In some embodiments, the second connecting frame and the body form a detachable structure by means of bolts; and the second connecting frame and the third rotary shaft are in sleeved connection.

In some embodiments, the slope portions are symmetrical about the central axis of the horizontal portion; and the horizontal portion is higher than an inner bottom end of the preformed groove.

In some embodiments, there are two groups of the preformed channels distributed; and the preformed channels and the separation cylinder for an integrated structure by means of opening grooves.

In some embodiments, the telescoping assembly includes a first rod body; a second rod body penetrates inside the first rod body; and the second rod body is connected to the first rod body by means of a spring.

In some embodiments, the first rod body and the second rod body form an elastic structure by means of the spring; and the central axis of the first rod body coincides with the central axis of the second rod body.

In some embodiments, both the first gear and the second gear are in meshing connection with the third gear; and the structure of the first gear matches the structure of the second gear.

### BRIEF DESCRIPTION OF THE DRAWINGS

FIG. 1 is a schematic diagram of a local structure of a body of a non-woven fabric separation mechanism for a dry-process paper machine according to an embodiment of the present disclosure.

FIG. 2 is a schematic diagram of a top-view structure of a non-woven fabric separation mechanism for a dry-process paper machine according to an embodiment of the present disclosure.

FIG. 3 is a schematic structural diagram of a first connecting frame of a non-woven fabric separation mechanism for a dry-process paper machine according to an embodiment of the present disclosure.

FIG. 4 is a schematic structural diagram of a telescoping assembly of a non-woven fabric separation mechanism for a dry-process paper machine according to an embodiment of the present disclosure.

FIG. 5 is a schematic diagram of a distribution structure of gears of a non-woven fabric separation mechanism for a dry-process paper machine according to an embodiment of the present disclosure.

In the drawings: 1, Body; 2, Supporting rod; 3, Conveyor assembly; 301, Conveyor wheel; 302, Conveyor belt; 4, Support frame; 5, Separation cylinder; 6, Adhesive band; 7, First rotary shaft; 8, First rolling cylinder; 9, Second rotary shaft; 10, Second rolling cylinder; 11, Third rotary shaft; 12, Motor; 13, Fixed rod; 14, First connecting frame; 15, Second connecting frame; 16, Movable cover; 17, Preformed channel; 18, Telescoping assembly; 1801, First rod body; 1802, Spring; 1803, Second rod body; 19, Preformed groove; 20, Slope portion; 21, Horizontal portion; 22, First gear; 23, Second gear; 24, Third gear; 25, Fixed magnet; 26, Clamping block; 27, Movable magnet.

### DETAILED DESCRIPTION OF THE EMBODIMENTS

The technical solutions in the embodiments of the present disclosure will be clearly and completely described below in combination with the drawings in the embodiments of the present disclosure. It is apparent that the described embodiments are only part of the embodiments of the present disclosure, not all the embodiments.

In descriptions of the present disclosure, unless otherwise stated, “a plurality of” means two or more than two; direction or position relationships indicated by terms such as “top”, “bottom”, “left”, “right”, “inside”, “outside”, “front”, “rear”, “head”, “tail” and the like are direction or position relationships based on the accompanying drawings, and are merely intended to facilitate the descriptions of the present disclosure and simplify the descriptions, rather than indicating or implying that a referred apparatus or element must have a particular direction or be constructed and operated in a particular direction. Therefore, these terms should not be interpreted as limiting the present disclosure. In addition, the terms “first”, “second”, “third”, and the like are for descriptive purposes only, and should not be construed as indicating or implying relative importance.

In the description of the present disclosure, it is to be noted that, unless otherwise clearly specified and limited, the terms “connected” and “connect” should be interpreted broadly. For example, the term “connect” may be fixed connection, detachable connection or integral construction. As an alternative, the term “connect” may be mechanical connection, or electrical connection. As an alternative, the term “connect” may be direct connection, or indirect connection by means of a medium. For those of ordinary skill in the art, specific meanings of the above terms in the present disclosure may be understood according to a specific condition.

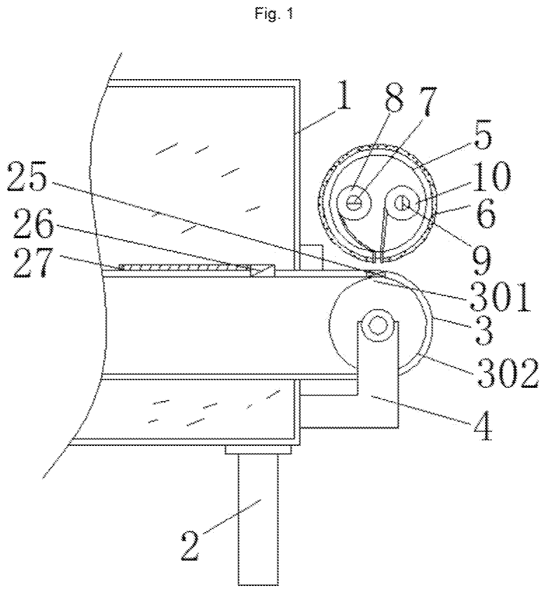

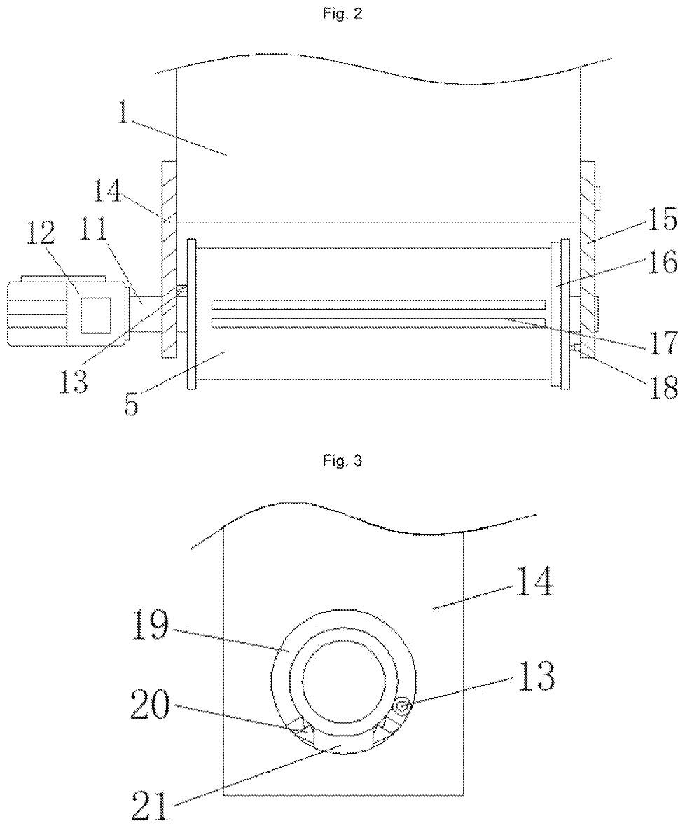

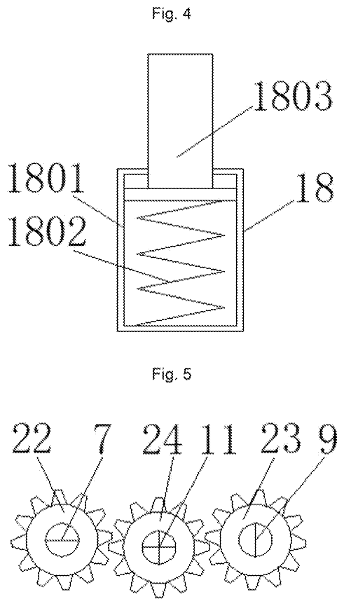

Referring to FIGS. 1-5, the present disclosure provides a technical solution: a non-woven fabric separation mechanism for a dry-process paper machine. The separation mechanism includes a body 1. A conveyor assembly 3 penetrates inside the body 1, and the conveyor assembly 3 is connected to the body 1 by means of a support frame 4; a separation cylinder 5 is mounted above the conveyor assembly 3; a third rotary shaft 11 penetrates inside the separation cylinder 5; and an end of the third rotary shaft 11 is connected to the body 1 by means of a first connecting frame 14, and the other side of the outer wall of the third rotary shaft 11 is connected to a second connecting frame 15. The first connecting frame 14 mainly plays a role in connecting and supporting relative distribution between the third rotary shaft 11 and the separation cylinder 5 and the body 1. The second connecting frame 15 and the body 1 form a detachable structure by means of bolts; and the second connecting frame 15 and the third rotary shaft 11 are in sleeved connection. By means of detaching the bolts, the second connecting frame 15 and the movable cover 16 in threaded connection with the separation cylinder 5 can be detached, such that people conveniently replace the rolling cylinders inside the separation cylinder 5 and the adhesive band 6. A motor 12 is mounted at an end portion of the third rotary shaft 11; a first rolling cylinder 8 is mounted on one inner side of the separation cylinder 5; the first rolling cylinder 8 is connected to the separation cylinder 5 by means of a first rotary shaft 7; a second rolling cylinder 10 is mounted on the other inner side of the separation cylinder 5; and the second rolling cylinder 10 is connected to the separation cylinder 5 by means of a second rotary shaft 9.

The non-woven fabric separation mechanism for a dry-process paper machine includes an adhesive band 6, the middle portion of the adhesive band 6 is placed on the outer wall of the separation cylinder 5; one end of the adhesive band 6 is in winding connection with the first rolling cylinder 8, and the other end of the adhesive band 6 is in winding connection with the second rolling cylinder 10; one side of the outer wall of the separation cylinder 5 is connected to a fixed rod 13, and a movable cover 16 is mounted on the other side of the outer wall of the separation cylinder 5; one side of the first connecting frame 14 that is close to the separation cylinder 5 is provided with a preformed groove 19, and slope portions 20 are distributed on the inner side of the preformed groove 19. The slope portions 20 are symmetrical about the central axis of the horizontal portion 21; and the horizontal portion 21 is higher than an inner bottom end of the preformed groove 19. The fixed rod 13 can move along the slope portions 20, until the fixed rod slides to the horizontal portion 21, such that the gear on one side of the outer wall of the third rotary shaft 11 and the gears at the rolling cylinders are in meshing transmission, so as to retrieve and release the adhesive band 6, thereby further facilitating subsequent separation of the separation mechanism. One sides of the slope portions 20 are connected to a horizontal portion 21; and a telescoping assembly 18 is connected to a lower part of the side of the second connecting frame 15 that is close to the separation cylinder 5. The telescoping assembly 18 includes a first rod body 1801; a second rod body 1803 penetrates inside the first rod body 1801; and the second rod body 1803 is connected to the first rod body 1801 by means of a spring 1802. The first rod body 1801 and the second rod body 1803 are form an elastic structure by means of the spring 1802; and the central axis of the first rod body 1801 coincides with the central axis of the second rod body 1803. Under the elastic action of the spring 1802, the first rod body 1801 and the second rod body 1803 can always push the separation cylinder 5, such that the fixed rod 13 on the end of the separation cylinder always moves on the inner side of the preformed groove 19, and is not easy to deviate.

A supporting rod 2 is connected on a bottom end of the body 1; the outer wall of the separation cylinder 5 is provided with a preformed channel 17. There are two groups of the preformed channels 17 distributed; and the preformed channels 17 and the separation cylinder 5 for an integrated structure by means of opening grooves. The preformed channels 17 distributed as two groups are mainly to allow the two ends of the adhesive band 6 to go in and out, so as to hide the adhesive band in the inner side of the separation cylinder 5, such that a distribution volume of the separation mechanism is reduced. The conveyor assembly 3 includes a conveyor belt 302, and a conveyor wheel 301 is wound on the inner wall of the conveyor belt 302; the conveyor wheel 301 is connected to the support frame 4 by means of an output shaft; a fixed magnet 25 is inlaid in the surface of the conveyor belt 302, and the surface of the conveyor belt 302 is connected to a clamping block 26; and a non-woven fabric body is placed on the surface of the conveyor belt 302, and a movable magnet 27 is mounted on one side of the non-woven fabric body. By means of the arrangement of the clamping block 26, the edge of the non-woven fabric body can be fixed; and the structure of the clamping block 26 is consistent with the structure of an existing common spring clamp, which is the related art. In addition, when the clamping block 26 moves with the conveyor belt 302, the non-woven fabric body can be driven to move, until the clamping block 26 moves downward along the surface of the conveyor wheel 301, such that the non-woven fabric body is driven to rotate. The movable magnet 27 connected to the end of the non-woven fabric body can perform a magnetic connection operation with the fixed magnet 25 close to the side of the clamping block 26, such that the non-woven fabric body is stabilized to be in a reverse flat state, and therefore, the separation mechanism conveniently separates impurities attached to both sides of the non-woven fabric body.

One side of the outer wall of the first rotary shaft 7 is connected to a first gear 22; a second gear 23 is mounted on one side of the outer wall of the second rotary shaft 9; and a third gear 24 is fixed on one side of the outer wall of the third rotary shaft 11. Both the first gear 22 and the second gear 23 are in meshing connection with the third gear 24; and the structure of the first gear 22 matches the structure of the second gear 23. By means of a meshing transmission operation between gear groups, the third gear 24 drives the first gear 22 and the second gear 23 to drive the first rotary shaft 7 connected to the first gear 22 and the second rotary shaft 9 connected to the second gear 23 to rotate, so as to assist the first rolling cylinder 8 and the second rolling cylinder 10 in retrieving and releasing the adhesive band 6.

To sum up, when the non-woven fabric separation mechanism for a dry-process paper machine is used, a dry-process paper machine is first started to process dispersed fibers in the body 1, so as to form a final product, the non-woven fabric. When the non-woven fabric is outputted, the surface of the non-woven fabric is still attached with scattered fibers, such that after the non-woven fabric is outputted by means of the conveyor assembly 3, the non-woven fabric is in contact with the separation cylinder 5 and the adhesive band 6, and therefore, the adhesive band 6 can adhere and separate the fibers on the surface of the non-woven fabric. Then, the motor 12 is started to drive the third rotary shaft 11 to rotate, such that each assembly connected to the third rotary shaft 11 synchronously rotates; and when a circle of the adhesive band 6 wound on the outer wall of the separation cylinder 5 is no longer sticky, the fixed rod 13 on one side of the outer wall of the separation cylinder 5 moves to the slope portions 20 along the inner side of the preformed groove 19, until the fixed rod moves to the horizontal portion 21, so as to cause the separation cylinder 5 to move; and then each assembly on the inner side of the separation cylinder is driven to move, so as to cause the first gear 22, the second gear 23 and the third gear 24 to be in meshing transmission, such that the first rolling cylinder 8 and the second rolling cylinder 10 respectively perform retrieving and releasing operations on the adhesive band 6, thereby rapidly completing the adjustment of the adhesive band 6, and therefore, the adhesive band 6 that completes adhesive separation is retrieved to the outer wall of the first rolling cylinder 8, and the adhesive band 6 that is not used is released from the outer wall of the second rolling cylinder 10, outputted via the inner side of the preformed channel 17, and wound on the surface of the separation cylinder 5; and a separation operation continues to be performed on the non-woven fabric. Finally, by means of detaching the bolts, the second connecting frame 15 and the movable cover 16 in threaded connection with the separation cylinder 5 can be detached, such that people conveniently replace the rolling cylinders inside the separation cylinder 5 and the adhesive band 6.

The present disclosure provides the non-woven fabric separation mechanism for a dry-process paper machine, which has the following beneficial effects.

1. In the non-woven fabric separation mechanism for a dry-process paper machine, by means of hiding a first rolling cylinder, a second rolling cylinder and an adhesive band inside the separation cylinder, the occupied space of the entire separation mechanism is small; and a non-adhesive side of the adhesive band is tightly attached to the outer wall of the separation cylinder, such that the adhesive side of the adhesive band faces outwards, so as to perform a separation operation on a non-woven fabric conveyed by the conveyor assembly and attachments on the surface of the non-woven fabric, thereby effectively accelerating a separation speed of the separation mechanism to the non-woven fabric.

2. In the non-woven fabric separation mechanism for a dry-process paper machine, when the adhesive band is respectively retrieved and releases by means of the first rolling cylinder and the second rolling cylinder, only the length of the adhesive band wrapped around the outer wall of the separation cylinder is exposed, and the amount of dust adhering to the surrounding environment is small, such that the using effect of the separation mechanism is effectively improved, and the non-woven fabric is better separated from the fibers attached to the surface of the non-woven fabric.

3. In the non-woven fabric separation mechanism for a dry-process paper machine, after the separation cylinder is driven to rotate by the third rotary shaft, the fixed rod on one side of the outer wall of the separation cylinder can slide along the inner side of the preformed groove; after the fixed rod moving along the slope portions, the fixed rod can push the separation cylinder to approach to the second connecting frame, such that each assembly on the inner side of the second connecting frame is driven to move, so as to cause the first gear, the second gear and the third gear to perform meshing transmission, thereby rapidly completing the adjustment of the adhesive band; and therefore, the adhesive band that completes adhesive separation is retrieved to the outer wall of the first rolling cylinder, and the adhesive band that is not used is released from the outer wall of the second rolling cylinder, and then the adhesive band that is not used wound on the surface of the separation cylinder.

4. In the non-woven fabric separation mechanism for a dry-process paper machine, after the clamping block moves with the conveyor belt, the non-woven fabric body can be driven to move, until the clamping block moves downward along the surface of the conveyor wheel, so as to drive the non-woven fabric body to rotate; and the movable magnet connected to the end of the non-woven fabric body can perform a magnetic connection operation with the fixed magnet close to the side of the clamping block, such that the non-woven fabric body is stabilized to be in a reverse flat state, and therefore, the separation mechanism conveniently separates impurities attached to both sides of the non-woven fabric body.

The above is only the preferred specific implementations of the present disclosure, but the scope of protection of the present disclosure is not limited thereto, any person skilled in the art who, within the technical scope disclosed in the present disclosure, make equivalent replacements or changes according to the technical solutions of the present disclosure and inventive idea thereof shall be covered within the scope of protection of the present disclosure.

1. A non-woven fabric separation mechanism for a dry-process paper machine, comprising a body (1), wherein a conveyor assembly (3) penetrates inside the body (1), and the conveyor assembly (3) is connected to the body (1) by means of a support frame (4); a separation cylinder (5) is mounted above the conveyor assembly (3); a third rotary shaft (11) penetrates inside the separation cylinder (5); an end of the third rotary shaft (11) is connected to the body (1) by means of a first connecting frame (14), and the other side of the outer wall of the third rotary shaft (11) is connected to a second connecting frame (15); a motor (12) is mounted at an end portion of the third rotary shaft (11); a first rolling cylinder (8) is mounted on one inner side of the separation cylinder (5); the first rolling cylinder (8) is connected to the separation cylinder (5) by means of a first rotary shaft (7); a second rolling cylinder (10) is mounted on the other inner side of the separation cylinder (5); and the second rolling cylinder (10) is connected to the separation cylinder (5) by means of a second rotary shaft (9); and
an adhesive band (6), wherein the middle portion of the adhesive band (6) is placed on the outer wall of the separation cylinder (5); one end of the adhesive band (6) is in winding connection with the first rolling cylinder (8), and the other end of the adhesive band (6) is in winding connection with the second rolling cylinder (10); one side of the outer wall of the separation cylinder (5) is connected to a fixed rod (13), and a movable cover (16) is mounted on the other side of the outer wall of the separation cylinder (5); one side of the first connecting frame (14) that is close to the separation cylinder (5) is provided with a preformed groove (19), and slope portions (20) are distributed on the inner side of the preformed groove (19); one sides of the slope portions (20) are connected to a horizontal portion (21); and a telescoping assembly (18) is connected to a lower part of the side of the second connecting frame (15) that is close to the separation cylinder (5).

2. The non-woven fabric separation mechanism for a dry-process paper machine as claimed in claim 1, wherein a supporting rod (2) is connected on a bottom end of the body (1); the outer wall of the separation cylinder (5) is provided with a preformed channel (17); the conveyor assembly (3) comprises a conveyor belt (302), and a conveyor wheel (301) is wound on the inner wall of the conveyor belt (302); the conveyor wheel (301) is connected to the support frame (4) by means of an output shaft; a fixed magnet (25) is inlaid in the surface of the conveyor belt (302), and the surface of the conveyor belt (302) is connected to a clamping block (26); and a non-woven fabric body is placed on the surface of the conveyor belt (302), and a movable magnet (27) is mounted on one side of the non-woven fabric body.

3. The non-woven fabric separation mechanism for a dry-process paper machine as claimed in claim 1, wherein one side of the outer wall of the first rotary shaft (7) is connected to a first gear (22); a second gear (23) is mounted on one side of the outer wall of the second rotary shaft (9); and a third gear (24) is fixed on one side of the outer wall of the third rotary shaft (11).

4. The non-woven fabric separation mechanism for a dry-process paper machine as claimed in claim 1, wherein the second connecting frame (15) and the body (1) form a detachable structure by means of bolts; and the second connecting frame (15) and the third rotary shaft (11) are in sleeved connection.

5. The non-woven fabric separation mechanism for a dry-process paper machine as claimed in claim 1, wherein the slope portions (20) are symmetrical about the central axis of the horizontal portion (21); and the horizontal portion (21) is higher than an inner bottom end of the preformed groove (19).

6. The non-woven fabric separation mechanism for a dry-process paper machine as claimed in claim 2, wherein there are two groups of the preformed channels (17) distributed; and the preformed channels (17) and the separation cylinder (5) for an integrated structure by means of opening grooves.

7. The non-woven fabric separation mechanism for a dry-process paper machine as claimed in claim 1, wherein the telescoping assembly (18) comprises a first rod body (1801); a second rod body (1803) penetrates inside the first rod body (1801); and the second rod body (1803) is connected to the first rod body (1801) by means of a spring (1802).

8. The non-woven fabric separation mechanism for a dry-process paper machine as claimed in claim 7, wherein the first rod body (1801) and the second rod body (1803) form an elastic structure by means of the spring (1802); and the central axis of the first rod body (1801) coincides with the central axis of the second rod body (1803).

9. The non-woven fabric separation mechanism for a dry-process paper machine as claimed in claim 3, wherein both the first gear (22) and the second gear (23) are in meshing connection with the third gear (24); and the structure of the first gear (22) matches the structure of the second gear (23).
